(19) United States
(12) Patent Application Publication
(10) Pub. No.: US 2017/0041997 A1
(43) Pub. Date: Feb. 9, 2017

(54) Light Emitting Diode Illumination Combination Kit

(71) Applicant: Yuhua Wang, Beijing (CN)

(72) Inventor: Yuhua Wang, Beijing (CN)

(21) Appl. No.: 15/298,444

(22) Filed: Oct. 20, 2016

Related U.S. Application Data
(63) Continuation-in-part of application No. PCT/CN2015/077261, filed on Apr. 23, 2015.
Application No. PCT/CN2015/077261 is a continuation-in-part of application No. PCT/CN2016/080490, filed on Apr. 28, 2016.

(30) Foreign Application Priority Data
Apr. 24, 2014 (CN) 201420205733.4
Jul. 29, 2015 (CN) 201520576689.2

(51) Int. Cl. H05B 33/08; F21V 21/08; F21S 4/22; F21V 23/04

(52) U.S. Cl. CPC H05B 33/0845; F21V 23/0407; F21V 21/0808; F21S 4/22; H05B 33/0857; F21V 3/0445

(57) ABSTRACT

A light emitting diode (LED) illumination combination kit includes one or a plurality of modular illumination units and a power supply device which supplies power to the LED illumination combination kit. Each of the modular illumination units includes a plurality of LED element luminous spots and an electronic component for voltage regulation serially connected to the LED element luminous spots. The modular illumination units are installed on a flexible plastic bottom plate or packaged in a flexible plastic outer case. When the plurality of modular illumination units are included in the LED illumination combination kit, illumination unit modules are parallelly connected into a long strip. Each of the LED element luminous spots is a monochromatic light luminous spot or a polychromatic light luminous spot.

### CROSS-REFERENCE TO RELATED APPLICATIONS

The present application is a continuation-in-part of PCT Application No. PCT/CN2015/077261, filed Apr. 23, 2015, which claims the benefit of Chinese Patent Application No. 201420205733.4, filed Apr. 24, 2014. The present application is also a continuation-in-part of PCT Application No. PCT/CN2016/080490, filed Apr. 28, 2016, which claims the benefit of Chinese Patent Application No. 201520576689.2, filed Jul. 29, 2015. The disclosures of each of these applications are hereby incorporated in their entirety by reference.

### FIELD OF THE INVENTION

The present invention relates to an illumination combination kit based on light emitting diodes (hereinafter, referred to as LEDs).

### BACKGROUND OF THE INVENTION

Illumination devices based on LEDs have been getting popular and have been put into practical use. The present invention provides an illumination combination kit based on LED modules which is conveniently operable and capable of selecting various power supplies.

### SUMMARY OF THE INVENTION

The present invention provides a light emitting diode (LED) illumination combination kit, the LED illumination combination kit comprises one or a plurality of modular illumination units each of which includes a plurality of LED elements and an electronic component for voltage regulation serially connected to the LED elements, the modular illumination units are installed on a flexible plastic bottom plate or packaged in a flexible plastic outer case, and when the plurality of modular illumination units are included in the LED illumination combination kit, illumination unit modules are parallelly connected into a long strip, and the LED illumination combination kit further comprises a power supply device which supplies power to the LED illumination combination kit.

Wherein each of the modular illumination units has three LED elements, the electronic component for voltage regulation is a resistor, and the power supply device provides a direct current (DC) power of 12 V.

The present invention also provides a light emitting diode (LED) illumination combination kit, the LED illumination combination kit comprises one or a plurality of modular illumination units, a control device for controlling the LED illumination combination kit, and a power supply device which supplies power to the LED illumination combination kit, wherein each of the modular illumination units includes a plurality of LED element luminous spots and an electronic component for voltage regulation serially connected to the LED element luminous spots, the modular illumination units are installed on a flexible plastic bottom plate or packaged in a flexible plastic outer case, and when the plurality of modular illumination units are included in the LED illumination combination kit, illumination unit modules are parallelly connected into a long strip, and each of the LED element luminous spots is a monochromatic light luminous spot with one red (R), green (G), blue (B) or white LED element.

Wherein each of the modular illumination units has three LED element luminous spots, the power supply device provides a DC power of 12 V, and the electronic component for voltage regulation is a resistor.

Wherein the power supply device obtains a DC power of 12 V from a cigarette lighter in an automobile, or obtains a DC power of 12 V by voltage transformation and current rectification from an indoor alternating current (AC) power supply of 100˜240 V, or provides a DC power of 12 V through a rechargeable battery.

Wherein an outer cover made of transparent plastics is provided to a light-emitting surface of one illumination unit module, or when a plurality of illumination unit modules are connected into a long strip, an outer cover made of transparent plastics is provided to a light-emitting surface of the whole long strip.

Wherein an adhesive film having double-sided adhesiveness is provided to a non light-emitting surface of one illumination unit module, or when a plurality of illumination unit modules are connected into a long strip, an adhesive film having double-sided adhesiveness is provided to a non light-emitting surface of the whole long strip.

Wherein the control device for controlling the LED illumination combination kit regulates or controls brightness of an emitted monochromatic light in a stepwise or stepless manner.

Wherein the control device further includes a device causing the emitted monochromatic light to blink.

The present invention further provides a light emitting diode (LED) illumination combination kit, the LED illumination combination kit comprises one or a plurality of modular illumination units, a control device for controlling the LED illumination combination kit, and a power supply device which supplies power to the LED illumination combination kit, wherein each of the modular illumination units includes a plurality of LED element luminous spots and electronic components for voltage regulation serially connected to the LED element luminous spots, the modular illumination units are installed on a flexible plastic bottom plate or packaged in a flexible plastic outer case, and when the plurality of modular illumination units are included in the LED illumination combination kit, illumination unit modules are parallelly connected into a long strip, and each of the LED element luminous spots has one red LED element, one green LED element and one blue LED element which get close together into a polychromatic light luminous spot, respective LED elements of the same color of the LED element luminous spots are serially connected to each other and serially connected to respective electronic components for voltage regulation and then become a parallel circuit emitting red, green and blue lights, and brightness of lights emitted by the red, green and blue LED elements is changed so that each LED element luminous spot emits lights with a variety of colors.

Wherein each of the modular illumination units has three LED element luminous spots, the power supply device provides a DC power of 12 V, and the electronic component for voltage regulation is a resistor.

Wherein the power supply device obtains a DC power of 12 V from a cigarette lighter in an automobile, or obtains a DC power of 12 V by voltage transformation and current rectification from an indoor AC power supply of 100˜240 V, or provides a DC power of 12 V through a rechargeable battery.

Wherein an outer cover made of transparent plastics is provided to a light-emitting surface of one illumination unit module, or when a plurality of illumination unit modules are connected into a long strip, an outer cover made of transparent plastics is provided to a light-emitting surface of the whole long strip.

Wherein an adhesive film having double-sided adhesiveness is provided to a non light-emitting surface of one illumination unit module, or when a plurality of illumination unit modules are connected into a long strip, an adhesive film having double-sided adhesiveness is provided to a non light-emitting surface of the whole long strip.

Wherein the control device for controlling the LED illumination combination kit switches color of each polychromatic light luminous spot by changing brightness of the red, green and blue lights, and the control device includes a multi-point option switch and an integrated circuit by which brightness of the red, green and blue lights is configured.

Wherein the color of the light to be emitted selected through the multi-point option switch are changed from red to purple or changed from purple to red in a visible spectrum.

Wherein the control device further includes a device causing an emitted polychromatic light to blink.

Wherein an index dial for indicating the selected color of the light to be emitted is provided outside the control device correspondingly to the multi-point option switch.

### BRIEF DESCRIPTION OF THE DRAWINGS

FIG. 1 is a general schematic diagram of LED modules as basic units of an LED illumination combination kit according to a first implementation of the present invention.

FIGS. 2 to 4 are an A-A view, a B-B view and a C-C view in FIG. 1 respectively.

FIG. 5 is a schematic diagram of an electrical plug of the LED illumination combination kit according to the present invention.

FIG. 6 is a representative schematic diagram of a basic configuration of the LED illumination combination kit according to the present invention.

FIG. 7 is a schematic diagram of an electrical connection plug used when an automobile power supply is used in the present invention.

FIG. 8 is a schematic diagram of a conversion power supply device used when an indoor power supply is used in the present invention.

FIG. 9 is a schematic diagram of a rechargeable battery used in the present invention.

FIG. 10 is a schematic diagram of an extension conductor used in the present invention.

FIG. 11 is a schematic diagram of an LED illumination combination kit according to an alternative embodiment in the first implementation of the present invention.

FIGS. 12 and 13 are general schematic diagrams of LED modules as basic units of an LED illumination combination kit according to second and third implementations of the present invention.

FIGS. 14 to 16 are an A-A view, a B-B view and a C-C view in FIGS. 12 and 13 respectively.

FIG. 17 is a representative schematic diagram of the LED illumination combination kit according to the second implementation of the present invention.

FIG. 18 is a representative schematic diagram of the LED illumination combination kit according to the third implementation of the present invention.

FIG. 19 is a schematic block diagram of a control device 106 used in the third implementation of the present invention.

### DETAILED DESCRIPTION

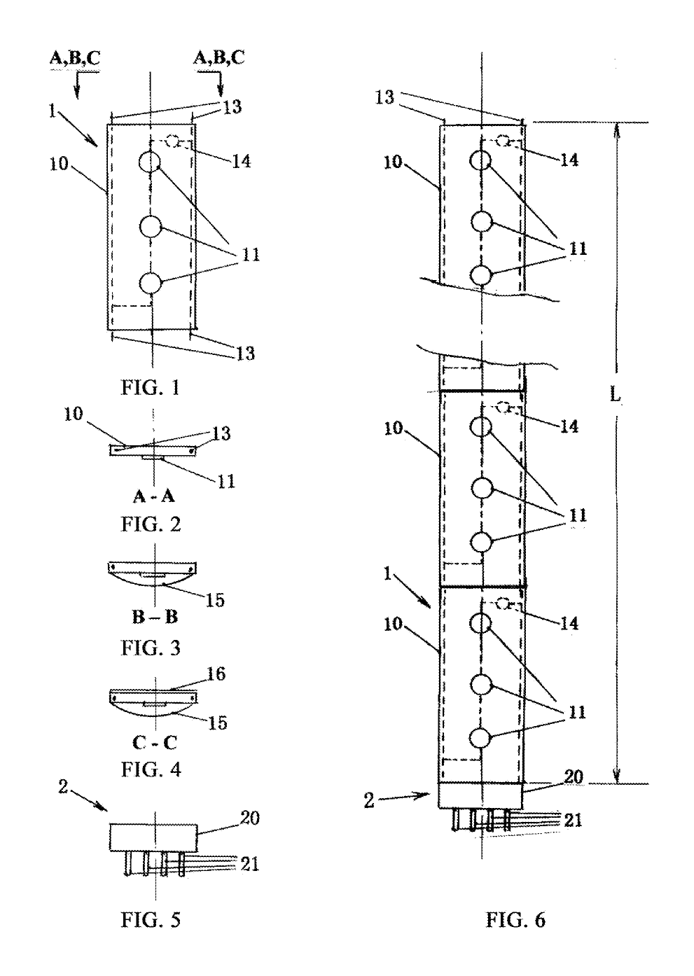

In FIG. 1, an LED module 1 comprises a plurality of (normally three) LEDs 11 and an electronic component 14 (normally a fixed resistor) for voltage regulation which are packaged in a flexible plastic outer case 10 and serially connected to each other, and both ends of the LED module 1 are connected to conductors 13 leading to a power supply (normally a DC power supply of 12 V). Broken lines in FIG. 1 represent connection conductors. In some implementations, the LEDs 11 and the electronic component 14 are installed on a flexible plastic bottom plate (this manner is not shown in FIG. 1) instead of being packaged in the manner shown in FIG. 1. An LED illumination combination kit according to the present invention will be constructed if a number of illumination unit modules (the LED modules) in FIG. 1 are parallelly connected to each other (that is, sequentially connected into a long strip along the conductors 13).

Herein, each of the LEDs emits a monochromatic light such as a red, green, blue or white light.

A DC operating voltage of about 3.7 V is normally used in one LED, a DC power supply of about 11.1 V is required for three LEDs connected in series, and a DC power supply of 12 V is applicable after an appropriate electronic component 14 for voltage regulation is added (normally, a fixed resistor having a proper resistance is serially connected to the LEDs).

FIG. 2 is an A-A view in FIG. 1, showing a structure of the illumination basic unit 1 from another direction. Reference numerals in FIG. 2 denote components the same as those shown in FIG. 1.

FIG. 3 is a B-B view in FIG. 1, showing that an outer cover 15 made of transparent plastics is provided to a light-emitting surface of the illumination basic unit 1 so that a dust/rain proof function will be achieved when the LED illumination combination kit is used outdoors.

FIG. 4 is a C-C view in FIG. 1, showing that an adhesive film (or a double-sided gummed paper) 16 having double-sided adhesiveness is provided to a non light-emitting surface of the illumination basic unit 1 so that the LED illumination combination kit can be bonded (adhered) to an adequate surface in use.

FIG. 5 shows an electrical plug 2 having a plug jacket 20 and electrical pins 21. At least two electrical pins 21 are used (to correspond to positive and negative electrodes of a DC power supply). The number of the electrical pins 21 in FIG. 5 is four, which means electrical pins used otherwise or idle electrical pins may be included.

FIG. 6 shows a configuration in which the conductors 13 of a number of the illumination basic units 1 are connected (actually, parallelly connected) to each other and one end of which is installed with the electrical plug 2.

Each of the illumination basic units 1 has a constant length, for example 5 cm (or 2 inches). A symbol L in FIG. 6 designates a total length of the illumination basic units. The total length of the illumination basic units can be calculated by a formula L=a×n (a is the length of each illumination basic unit, and n is the number of the illumination basic units). For example, the present invention may provide LED illumination combination kits having two, three, six, nine or twelve illumination basic units so that a user can flexibly and conveniently select among them, and thus they are especially adaptable to be used in an automobile.

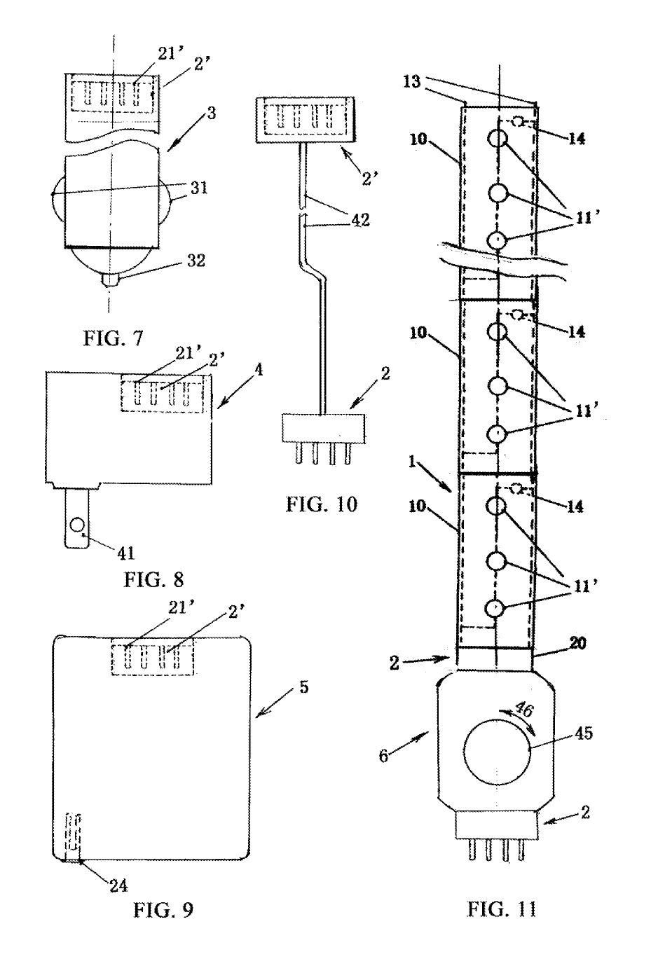

FIG. 7 shows an electrical connection plug 3 which has a positive electrode 32 and a negative electrode 31 connected to a power supply of a cigarette lighter in an automobile and further has an electrical socket 2′ with a hole 21′ matchable with the electrical plug 2 for receiving the electrical plug 2.

FIG. 8 shows a conversion power supply device 4 which has a plug 41 to be inserted into an indoor AC power supply of 100˜240 V and an electrical socket 2′ with a hole 21′ matchable with the electrical plug 2 for receiving the electrical plug 2. Electronic elements and circuits within the conversion power supply device 4 belong to the conventional art and are omitted herein.

FIG. 9 shows a rechargeable battery 5 in which an charging input hole 24 and an electrical socket 2′ with a hole 21′ matchable with the electrical plug 2 for receiving the electrical plug 2 are provided.

In FIGS. 7-9, two or more electrical sockets 2′ may be provided for convenience by adjusting positions of the electrical sockets 2′ (not shown in FIGS. 7-9). However, at most two electrical sockets 2′ are generally provided, otherwise there is no enough space to accommodate them.

In FIG. 10, the electrical plug 2 is provided on one end of a conductor cable 42, and the electrical socket 2′ for receiving the electrical plug 2 is provided on the other end of the conductor cable 42. The conductor cable 42 is used for extended connection when the LED illumination combination kit is distant from a power supply.

In FIG. 11, LEDs 11′ of each of the illumination basic units emit lights with a variety of colors changed in an order of a visible spectrum. An electrical socket into which an electrical plug 2 on an end of the illumination basic units combined together into a long strip is inserted is provided on one end of a control device 6, and an electrical plug 2 for accessing a power supply is provided on the other end of the control device 6. The control device 6 has a control knob 45 which is rotatable as indicated by an arched two-headed arrow 46 to select the color of the light to be emitted.

The LED illumination combination kit according to the first implementation of the present invention can be modified to have the following alternative embodiments (not shown in FIGS. 1-11).

A control device which causes the LEDs to produce a blinking effect of light-up and turn-off may be additionally installed to the LED illumination combination kit emitting a monochromatic light shown in FIG. 6. A frequency for blinking may be regulated or modified. A proportion of durations for light-up and turn-off in blinking may also be regulated or modified.

It is possible that the electrical socket 2′ for receiving the electrical plug 2 is provided on one end of the conductor cable (an extension conductor) 42 shown in FIG. 10 and a USB plug to be connected to a computer in place of the electrical plug 2 is provided on the other end of the conductor cable 42, and a conversion device which converts a DC power of 5 V into a DC power of 12 V is provided at the same time. In this way, the LEDs can access a power supply from the computer and light up.

The following functions may be assigned to the control device 6 of the LED illumination combination kit emitting a polychromatic light in a visible spectrum shown in FIG. 11.

(1) Colors of lights are continuously changed from one end of the visible spectrum to the other end of the visible spectrum. Directions in which the colors of lights are changed (from red to purple or from purple to red) are optional. A duration in which the colors of lights are changed for one cycle period may be regulated or modified.

(2) Colors of lights are changed in a stepwise manner from one end of the visible spectrum to the other end of the visible spectrum, and the whole spectrum can be divided into steps the number of which is adjustable and variable (for example, seven steps, sixteen steps, or steps with another number). Directions in which the colors of lights are changed (from red to purple or from purple to red) are optional. A duration in which the colors of lights are changed for one cycle period may be regulated or modified.

(3) The red, green and blue colors jump in turn among them. A frequency for jumping may be regulated or modified.

(4) A control device for regulating brightness of lights is additionally installed. Brightness of lights may be regulated in a stepwise (for example, sixteen steps or steps with another number) or stepless manner.

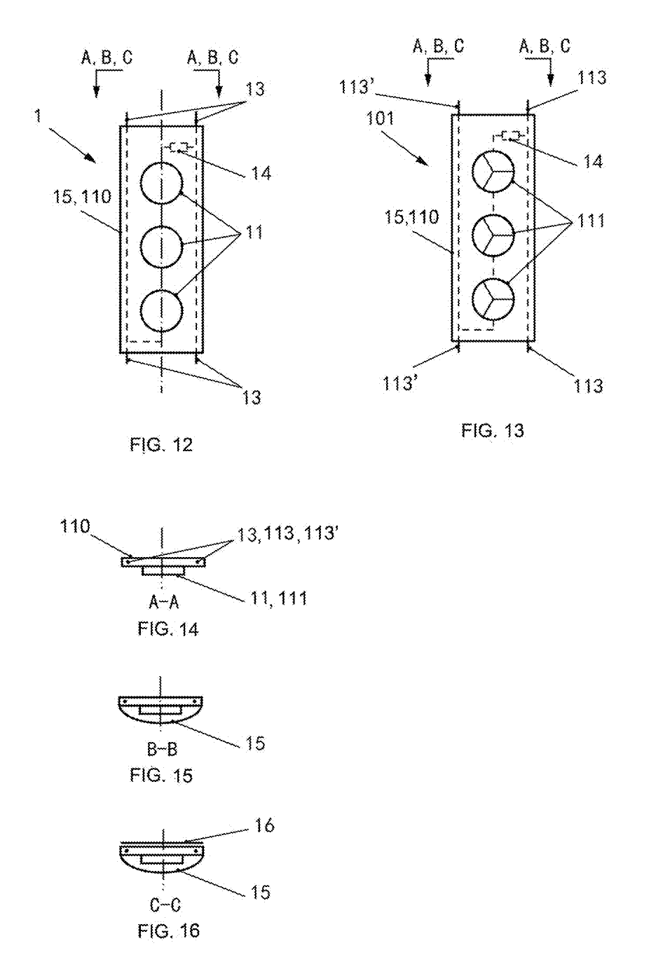

FIG. 12 shows an LED module 1 which comprises a plurality of (normally three) LEDs 11 as luminous spots and an electronic component 14 (normally a fixed resistor) for voltage regulation which are installed on a flexible plastic bottom plate 110 and serially connected to each other, and both ends of the LED module 1 are connected to conductors 13 leading to a power supply (normally a DC power supply of 12 V). Broken lines in FIG. 12 represent connection conductors. A light emitting section of the LED illumination combination kit according to the present invention will be constructed if a number of illumination basic units (the LED modules) in FIG. 12 are parallelly connected to each other (that is, sequentially connected into a long strip along the conductors 13).

Herein, each of the LEDs emits a monochromatic light such as a red, green, blue or white light.

A DC operating voltage of about 3.7 V is normally used in one LED, a DC power supply of about 11.1 V is required for three LEDs connected in series, and a DC power supply of 12 V is applicable after an appropriate electronic component 14 for voltage regulation is added (normally, a fixed resistor having a proper resistance is serially connected to the LEDs).

FIG. 13 shows an LED module 101, and the LED module 101 has a structure similar to that of the illumination basic unit 1 according to the second implementation shown in FIG. 12 except the following differences. (1) Each of the luminous spots 11 in FIG. 12 is a single LED emitting a monochromatic light, while each of the luminous spots 111 in FIG. 13 has three LEDs (one red LED, one green LED and one blue LED) getting close together. Visible lights with a variety of colors can be emitted from each of the luminous spots 111 through a control circuit (generally an application specific integrated circuit) which controls intensity (brightness) of lights of respective colors. (2) The conductors 13 in FIG. 12 generally need a single conductor to complete a closed circuit, while a conductor bundle (cable) 113 in FIG. 13 needs three conductors which provide the power configured by the control circuit to the red, green and blue LEDs respectively and a return conductor 113′ in FIG. 13 only needs a single conductor to complete a closed circuit. In the meanwhile, each of the three light emitting circuits of the red, green and blue LEDs needs one electronic component 14 for voltage regulation (that is, each branch of the conductor bundle (cable) 113 in FIG. 13 is serially connected to one electronic component 14).

FIG. 14 is an A-A view in FIGS. 12-13, showing a structure of the illumination basic units 1 and 101 from another direction. Reference numerals in FIG. 14 denote components the same as those shown in FIGS. 12-13.

FIG. 15 is a B-B view in FIGS. 12-13, showing that an outer cover 15 made of transparent plastics is provided to light-emitting surfaces of the illumination basic units 1 and 101 so that a dust/rain proof function will be achieved when the LED illumination combination kit is used outdoors.

FIG. 16 is a C-C view in FIGS. 12-13, showing that an adhesive film (or a double-sided gummed paper) 16 having double-sided adhesiveness is provided to non light-emitting surfaces of the illumination basic units 1 and 101 so that the LED illumination combination kit can be bonded (adhered) to an adequate surface in use.

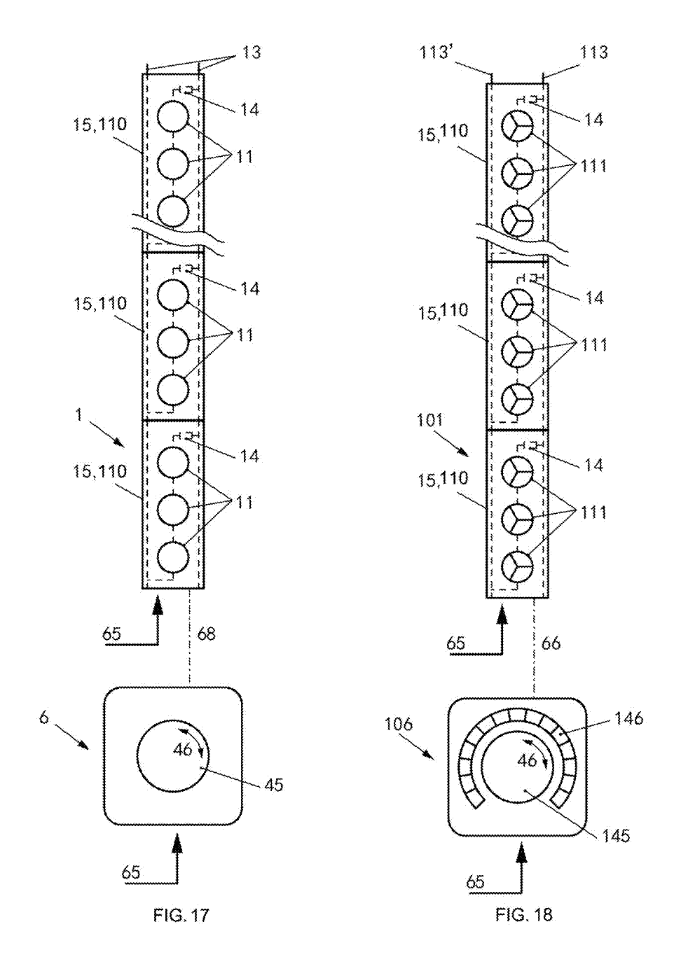

FIG. 17 shows a state in which a number of the LED modules 1 are engaged with each other into a long strip, that is, the conductors 13 of each LED module are serially connected into a long strip but the circuits of the LED modules are brought into a condition in which the LED modules are parallelly connected to each other. The number of the LED modules 1 connected in parallel is not particularly defined, and it depends upon capacities of the power supplies and the conductors and actual requirements for the products. The control device 6 of the LED illumination combination kit is connected to the LED modules (generally a plug-socket connection) as indicated by a dot-and-dash line 68. When the control device 6 is far from the LED modules 1, extension conductors can be used. The knob 45 of the control device 6 is rotated as indicated by the two-headed arrow 46 to regulate brightness of the lights emitted by the LEDs. Arrows 65 in FIG. 17 indicate the power supplied from a power supply device. The available power supplies have been described hereinbefore, and will not be repeated. In FIG. 17, the arrows 65 are marked at two positions respectively indicating two using conditions: one is a case in which the control device 6 is used and the power supply is led to the control device 6 to control the LED modules; and the other is a case in which the power supply is directly connected to the LED modules (generally a plug-socket connection) without using the control device 6 and only one kind of brightness is emitted because brightness of lights is not regulated.

FIG. 18 shows a state in which a number of the LED modules 101 in FIG. 13 are engaged with each other into a long strip, that is, the return conductor 113′ and the conductor cable 113 of each LED module are serially connected into a long strip but the circuits of the LED modules are brought into a condition in which the LED modules are parallelly connected to each other. The number of the LED modules 101 connected in parallel is not particularly defined, and it depends upon capacities of the power supplies and the conductors and actual requirements for the products. The control device 106 of the LED illumination combination kit is connected to the LED modules (generally a plug-socket connection) as indicated by a dot-and-dash line 66. When the control device 106 is far from the LED modules 101, extension conductors can be used. The control device 106 has a knob 145 which is rotatable as indicated by the two-headed arrow 46 to switch colors of the polychromatic lights emitted by the LEDs. A color scale 146 for indicating the color of the light to be emitted is provided to cooperate with the knob 145. Arrows 65 in FIG. 18 indicate the power supplied from a power supply device. The available power supplies have been described hereinbefore, and will not be repeated. In FIG. 18, the arrows 65 are marked at two positions respectively indicating two using conditions: one is a case in which the control device 106 is used and the power supply is led to the control device 6 to control the LED modules to switch colors; and the other is a case in which the power supply is directly connected to the LED modules (usually a plug-socket connection) without using the control device 106 and only the light with one kind of color (generally a white light combined by red, green and blue lights) is emitted because colors of lights are not controlled (switched).

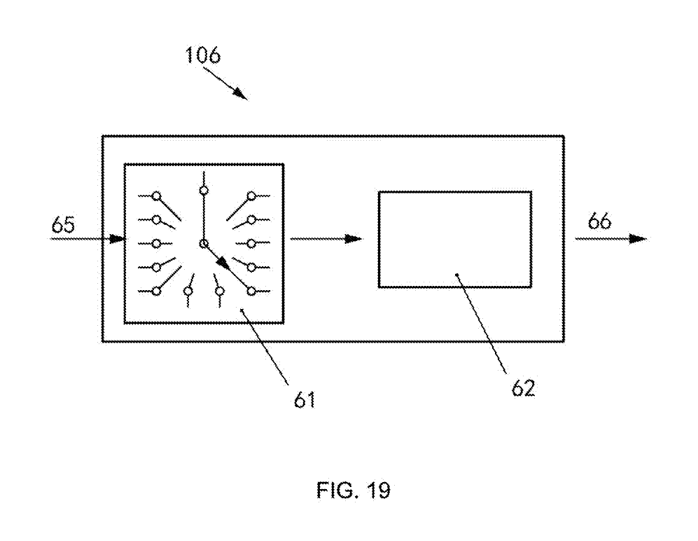

As shown in FIG. 19, an arrow 65 indicates that power is supplied from a power supply device to a multi-point option switch 61 which is controlled by the knob 145 provided outside a cabinet to change (switch) the colors of the lights to be emitted. The circuit selected through the multi-point option switch 61 is connected to a control circuit 62 (generally an application specific integrated circuit). An output circuit of the control circuit 62 is connected to the LED modules 101 shown in FIG. 18 via conductors (or cables) so as to emit the light with the selected color.

The LED illumination combination kit according to the present invention can be modified to have the following alternative embodiments (not shown in FIGS. 12-19).

A controlling function of causing the LEDs to produce a blinking effect of light-up and turn-off may be affixed to the control device 6 of the LED illumination combination kit emitting a monochromatic light according the second implementation of the present invention shown in FIG. 17. A frequency for blinking may be regulated or modified. A proportion of durations for light-up and turn-off in blinking may also be regulated or modified.

A controlling function of causing the LEDs to produce a blinking effect of light-up and turn-off may be affixed to the control device 106 of the LED illumination combination kit emitting a polychromatic light according the third implementation of the present invention shown in FIG. 18. A frequency for blinking may be regulated or modified. A proportion of durations for light-up and turn-off in blinking may also be regulated or modified.

The following functions may be assigned to the control device 106 of the LED illumination combination kit emitting a polychromatic light shown in FIG. 18.

(1) Colors of lights are changed from one end to the other end of the visible spectrum. Directions in which the colors of lights are changed (from red to purple or from purple to red) are optional. A duration in which the colors of lights are changed for one cycle period may be regulated or modified.

(2) The red, green and blue colors jump in turn among them. A frequency for jumping may be regulated or modified.

(3) A control device for regulating brightness of lights is additionally installed. Brightness of lights may be regulated in a stepwise (for example, sixteen steps or steps with another number) or stepless manner.

What is claimed is:

1. A light emitting diode (LED) illumination combination kit, comprising one or a plurality of modular illumination units each of which includes a plurality of LED elements and an electronic component for voltage regulation serially connected to the LED elements, wherein the modular illumination units are installed on a flexible plastic bottom plate or packaged in a flexible plastic outer case, and when the plurality of modular illumination units are included in the LED illumination combination kit, illumination unit modules are parallelly connected into a long strip, and
a power supply device which supplies power to the LED illumination combination kit.

2. The LED illumination combination kit according to claim 1, wherein
each of the modular illumination units has three LED elements, the electronic component for voltage regulation is a resistor, and the power supply device provides a DC power of 12 V.

3. A light emitting diode (LED) illumination combination kit, comprising one or a plurality of modular illumination units, a control device for controlling the LED illumination combination kit, and a power supply device which supplies power to the LED illumination combination kit,
wherein each of the modular illumination units includes a plurality of LED element luminous spots and an electronic component for voltage regulation serially connected to the LED element luminous spots, the modular illumination units are installed on a flexible plastic bottom plate or packaged in a flexible plastic outer case, and when the plurality of modular illumination units are included in the LED illumination combination kit, illumination unit modules are parallelly connected into a long strip, and
each of the LED element luminous spots is a monochromatic light luminous spot with one red, green, blue or white LED element.

4. The LED illumination combination kit according to claim 3, wherein
each of the modular illumination units has three LED element luminous spots, the power supply device provides a DC power of 12 V, and the electronic component for voltage regulation is a resistor.

5. The LED illumination combination kit according to claim 3, wherein
the power supply device obtains a DC power of 12 V from a cigarette lighter in an automobile, or obtains a DC power of 12 V by voltage transformation and current rectification from an indoor AC power supply of 100˜240 V, or provides a DC power of 12 V through a rechargeable battery.

6. The LED illumination combination kit according to claim 3, wherein
an outer cover made of transparent plastics is provided to a light-emitting surface of one illumination unit module, or when a plurality of illumination unit modules are connected into a long strip, an outer cover made of transparent plastics is provided to a light-emitting surface of the whole long strip.

7. The LED illumination combination kit according to claim 3, wherein
an adhesive film having double-sided adhesiveness is provided to a non light-emitting surface of one illumination unit module, or when a plurality of illumination unit modules are connected into a long strip, an adhesive film having double-sided adhesiveness is provided to a non light-emitting surface of the whole long strip.

8. The LED illumination combination kit according to claim 3, wherein
the control device for controlling the LED illumination combination kit regulates or controls brightness of an emitted monochromatic light in a stepwise or stepless manner.

9. The LED illumination combination kit according to claim 8, wherein
the control device further includes a device causing the emitted monochromatic light to blink.

10. A light emitting diode (LED) illumination combination kit, comprising one or a plurality of modular illumination units, a control device for controlling the LED illumination combination kit, and a power supply device which supplies power to the LED illumination combination kit,
wherein each of the modular illumination units includes a plurality of LED element luminous spots and electronic components for voltage regulation serially connected to the LED element luminous spots, the modular illumination units are installed on a flexible plastic bottom plate or packaged in a flexible plastic outer case, and when the plurality of modular illumination units are included in the LED illumination combination kit, illumination unit modules are parallelly connected into a long strip, and
wherein each of the LED element luminous spots has one red LED element, one green LED element and one blue LED element which get close together into a polychromatic light luminous spot, respective LED elements of the same color of the LED element luminous spots are serially connected to each other and serially connected to respective electronic components for voltage regulation and then become a parallel circuit emitting red, green and blue lights, and brightness of lights emitted by the red, green and blue LED elements is changed so that each LED element luminous spot emits lights with a variety of colors.

11. The LED illumination combination kit according to claim 10, wherein
each of the modular illumination units has three LED element luminous spots, the power supply device provides a DC power of 12 V, and the electronic component for voltage regulation is a resistor.

12. The LED illumination combination kit according to claim 10, wherein
the power supply device obtains a DC power of 12 V from a cigarette lighter in an automobile, or obtains a DC power of 12 V by voltage transformation and current rectification from an indoor AC power supply of 100˜240 V, or provides a DC power of 12 V through a rechargeable battery.

13. The LED illumination combination kit according to claim 10, wherein
an outer cover made of transparent plastics is provided to a light-emitting surface of one illumination unit module, or when a plurality of illumination unit modules are connected into a long strip, an outer cover made of transparent plastics is provided to a light-emitting surface of the whole long strip.

14. The LED illumination combination kit according to claim 10, wherein
an adhesive film having double-sided adhesiveness is provided to a non light-emitting surface of one illumination unit module, or when a plurality of illumination unit modules are connected into a long strip, an adhesive film having double-sided adhesiveness is provided to a non light-emitting surface of the whole long strip.

15. The LED illumination combination kit according to claim 10, wherein
the control device for controlling the LED illumination combination kit switches color of each polychromatic light luminous spot by changing brightness of the red, green and blue lights, and the control device includes a multi-point option switch and an integrated circuit by which brightness of the red, green and blue lights is configured.

16. The LED illumination combination kit according to claim 15, wherein
the colors of the lights to be emitted selected through the multi-point option switch are changed from red to purple or changed from purple to red in a visible spectrum.

17. The LED illumination combination kit according to claim 15, wherein
the control device further includes a device causing an emitted polychromatic light to blink.

18. The LED illumination combination kit according to claim 15, wherein
an index dial for indicating the selected color of the light to be emitted is provided outside the control device correspondingly to the multi-point option switch.
